(19) United States
(12) Patent Application Publication
(10) Pub. No.: US 2004/0155154 A1
(43) Pub. Date: Aug. 12, 2004

(54) Structure with variable emittance

(76) Inventor: Alexander John Topping, Oxford (GB)

Correspondence Address: WENDEROTH, LIND & PONACK, L.L.P., 2033 K STREET N. W., SUITE 800, WASHINGTON, DC, 20006-1021, US

(21) Appl. No.: 10/473,775

(22) PCT Filed: Mar. 22, 2002
(86) PCT No.: PCT/GB02/01396

(30) Foreign Application Priority Data
Apr. 4, 2001 (GB) 0108502.6

(51) Int. Cl. B64G 1/22

(52) U.S. Cl. 244/158 R

(57) ABSTRACT

A structure is disclosed which comprises a thermochromic layer located between a front layer and a back layer, wherein the front layer is a dielectric and is in contact with the thermochromic layer, and wherein the back layer is reflective to infrared (IR) radiation. Below the thermochromic transition temperature of the thermochromic layer, the front layer and thermochromic layer are IR-transparent, so the structure is highly reflective to IR radiation because of the presence of the reflective back layer. Consequently, the structure has a low emittance in this state. Above the thermochromic transition temperature of the thermochromic layer, the device structure becomes IR-absorbent, so the reflectance of the structure is reduced and hence its emittance is increased. The front layer index-matches with the thermochromic layer above the transition temperature of the thermochromic layer to enable radiation to enter the thermochromic layer.

The present invention relates to a structure for which the emittance, and therefore the amount of electromagnetic radiation it is capable of radiating, is adjustable as a function of temperature.

It is important to control the temperature of a satellite in space so that sensitive components stay within their optimal operating temperature range and do not overheat or become too cool. In the vacuum of space, conduction and convection cannot be used to transfer heat from a satellite, so radiation is used for temperature control. A previous system comprises active radiator panels which are mounted on the satellite and which have a moving reflective louver system to selectively screen or expose an emissive panel to control radiation of heat from the satellite for achieving thermo-regulation.

Current active radiator panels have a number of significant problems. Firstly, they are relatively heavy, having a mass of the order of 5 kilograms per square metre, which is a big drawback for a device which must be launched into space. They are also relatively bulky in volume. The prior devices also have moving parts which makes them susceptible to damage, potentially unreliable and costly to fabricate. Some prior devices may also require a power source and control circuitry in order to operate which adds to their complexity, weight and cost.

A further problem exists in the field of thermal imaging. Thermal imaging cameras are available which are very sensitive to infrared radiation, however they only give an indication of the relative temperature difference between items. There is a problem that it is not possible to detect the absolute temperature of a body without knowing the emissivity of its surface.

It is therefore an object of the invention to alleviate the above problems.

Accordingly, the present invention provides a structure, having variable emittance, comprising: a front layer comprising a dielectric material; and a thermochromic layer comprising a thermochromic material, wherein the thermochromic material has a first state, below a transition temperature, in which the imaginary part of the refractive index of the thermochromic material has a first value, and a second state, above the transition temperature, in which the imaginary part of the refractive index of the thermochromic layer has a second value, greater than said first value, and wherein the magnitude of the difference between the real part of the refractive index of the thermochromic layer and the real part of the refractive index of the front layer when the thermochromic material is in the second state is smaller than or the same as when the thermochromic material is in said first state, such that the emittance of the structure when the thermochromic material is in the second state is greater than the emittance when the thermochromic material is in said first state.

The structure according to the invention can have a high reflectance (low emittance) below the thermochromic transition temperature of the thermochromic material, and a low reflectance (high emittance) above the thermochromic transition temperature of the thermochromic material. This enables it to be used as a thermal radiator for temperature regulation which retains heat when below the transition temperature and then switches to radiate thermal energy when above the transition temperature. No moving parts are required, and no control circuitry, power source or the like is required because the switching between low and high emittance states occurs as an intrinsic property of the structure in response to temperature change. The structure can reversibly cycle between the high and low emittance states. The emissive range can be large, such as 0.85. The structure can be made as an extremely thin panel or stack of layers, which has a small volume and low mass, such as in the region of only a few tenths of a kilogram per square metre. The operation of the structure is also reliable because it can be fabricated from materials known to be durable and because damage to any part of it will not affect the operation of other parts. The structure does not rely on interference effects for operation (though interference can additionally be employed); consequently is generally not sensitive to wavelength and can operate over a broad part of the electromagnetic spectrum, such as the thermal infrared; it is also generally insensitive to the angle of incident or emitted radiation.

The structure according to the invention can also be used as a temperature monitor because its emittance has defined values above and below the thermochromic transition temperature, and because there is a discrete switch in emittance above and below the transition temperature. Consequently, by sensing the radiation emitted by the structure, it is possible to determine whether it, or a body to which it is in thermal contact, is above or below the transition temperature (which can be predetermined). The radiation emitted can be monitored remotely.

Preferably, when the thermochromic material is in said a second state, above a transition temperature, the real part of the refractive index of the thermochromic layer is comparable to the real part of the refractive index of the front layer. This has the advantage that, by at least partial index matching, reflection of radiation at the interface between the front layer and the thermochromic layer is suppressed so that the majority of radiation can pass from the front layer to the thermochromic layer.

Advantageously, the thermochromic layer has a transition temperature in the range of from −25° C. to 100° C., more preferably −5° C. to 65° C., and more preferably in the range of from 10° C. to 30° C., because the structure can then be used for thermo-regulation in that temperature range.

Advantageously, the front layer comprises a cermet material. This enables the refractive index of the front layer to be tailored to match that of the thermochromic layer, even when no single fundamental substance of appropriate refractive index exists.

Preferably the refractive index of the front layer is graded from front to back, such that at the interface between the front layer and the thermochromic layer, the real parts of their refractive indexes substantially match. A graded refractive index can be achieved, for example, by varying the composition of the material, such as a cermet, comprising the front layer.

Preferably the structure further comprises a back layer, on the opposite side of the thermochromic layer to the front layer, said back layer being reflective to electromagnetic radiation. This has the advantage that the back layer enables the structure to have high reflectance (low emittance) below the thermochromic transition temperature of the thermochromic material.

Preferably, the structure according to the invention further comprises an optical cavity between the thermochromic layer and the back layer, and preferably the real part of the refractive index of the optical cavity is dissimilar to the real part of the refractive index of the thermochromic layer, more preferably the real part of the refractive index of the optical cavity is lower than the real part of the refractive index of the thermochromic layer. This has the advantage that the cavity can avoid index matching between the thermochromic layer and the back layer which might otherwise inhibit the back layer acting as a reflector.

Preferably, the structure comprises an anti-reflection (AR) coating in front of the thermochromic layer. The AR-coating can reduce the intrinsic minimum reflectance of the structure, and hence increase its maximum emittance, and increase the range through which the emittance is variable. The AR-coating can comprise the front layer itself, for example if the front layer has a thickness of substantially a quarter of the wavelength of the radiation in that medium, with the advantage of simplifying the structure, or the front layer can have a graded or stepped refractive index in order to index match to some extent with both the thermochromic layer and with the surroundings, which will thereby be inherently anti-reflective.

Advantageously, according to a further embodiment of the invention, the structure can comprise at least one further thermochromic layer, wherein each thermochromic layer has a different thermochromic transition temperature. This enables the structure to have a particular emittance for a band or bands of temperature, and the emittance changes at the transition temperatures above and below the predetermined band or bands.

Preferably the thermochromic layer comprises a dispersion of thermochromic material in a dielectric material host and/or the front layer comprises a dispersion of thermochromic material in a dielectric material host. This enables grading of the refractive index properties to reduce the inherent reflectance of the structure and thereby increase the modulation depth of the variable emittance. In a further preferred aspect of the invention, there is no defined interface between the front layer and the thermochromic layer, they can be one and the same or there can be a smooth transition between them, which also reduces interfacial reflectance. The structure is effectively a single switchable film, although the film is inhomogeneous and is better considered as a stack of many, many infinitesimally thin films each switchable, but with a slow change from low refractive index to high refractive index.

Further aspects of the invention provide a thermal radiator, a satellite, and a temperature monitor, each comprising a structure according to the invention above.

The invention also provides a method of thermal regulation of a body, comprising providing the body with at least one structure according to the above invention.

The invention further provides a method of temperature monitoring, comprising monitoring radiation from a structure according to the above invention, and determining whether the radiation emission is above or below at least one threshold value.

A further aspect of the present invention provides a structure, having variable emittance, comprising: a front layer comprising a dielectric material; and a thermochromic layer comprising a thermochromic material, wherein the thermochromic material has a first state, below a transition temperature, in which the imaginary part of the refractive index of the thermochromic material has a first value, and a second state, above the transition temperature, in which the imaginary part of the refractive index of the thermochromic layer has a second value, greater than said first value, and wherein the refractive index of the front layer and the refractive index of the thermochromic layer above and below the transition temperature are such that the emittance of the structure when the thermochromic material is in the second state is greater than the emittance when the thermochromic material is in said first state.

Preferably, the refractive index of the front layer and the refractive index of the thermochromic layer above and below the transition temperature are such that the reflectance between the layers when the thermochromic material is in the second state is less than or the same as when the thermochromic material is in the first state. Preferably the reflectance is the interfacial reflectance given by equation (1) below.

The invention will be further described, by way of example only, with reference to the accompanying drawings in which:

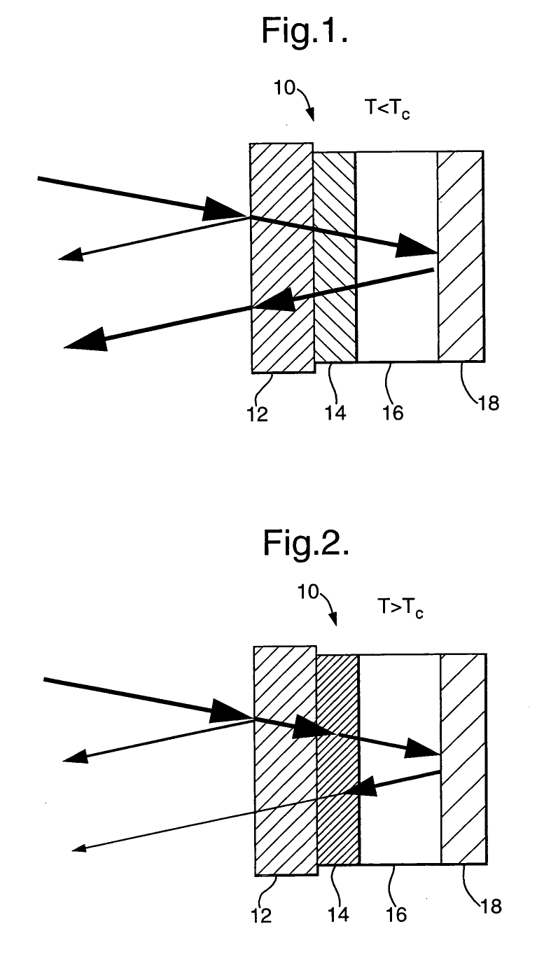

FIG. 1 illustrates in schematic cross-section a first embodiment of the invention in a first, cold, state;

FIG. 2 illustrates in schematic cross-section the first embodiment of the invention in a second, hot, state;

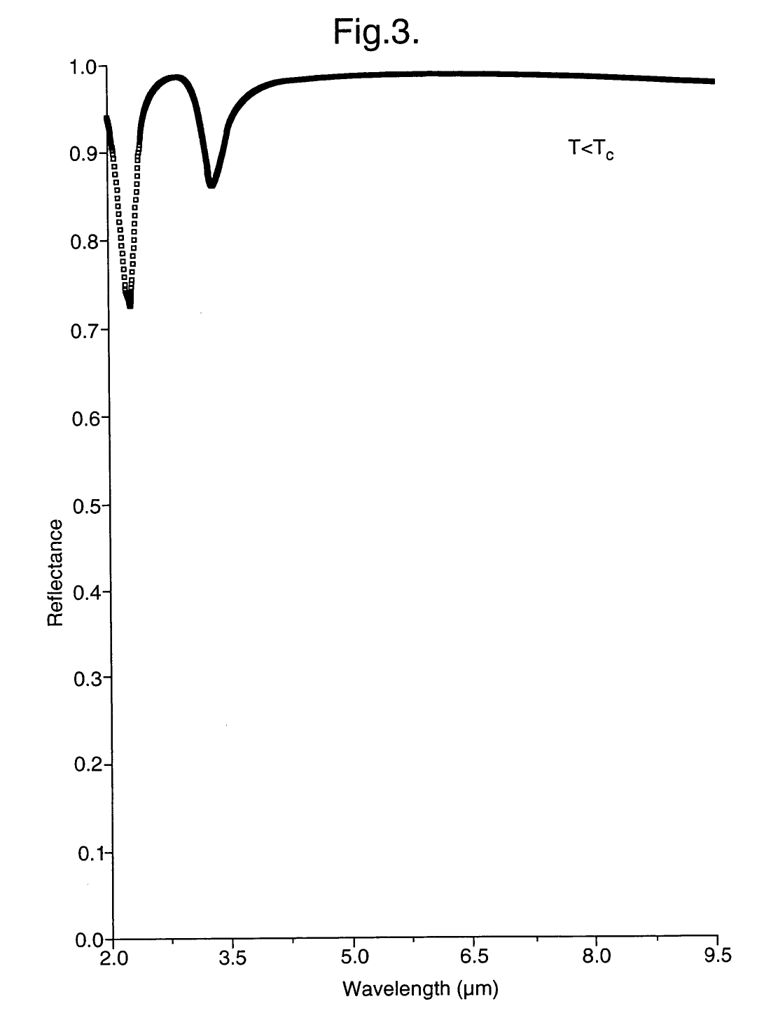

FIG. 3 is a graph of reflectance versus wavelength for the embodiment of the structure of FIG. 1 in its first state;

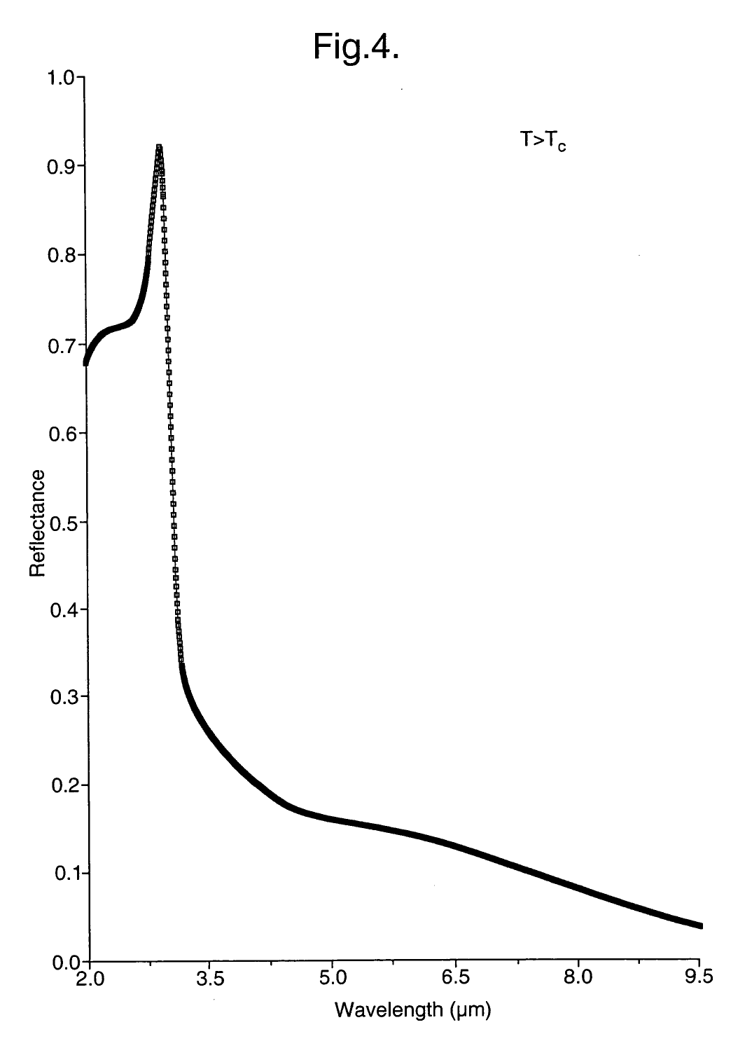

FIG. 4 is a graph of reflectance versus wavelength for the embodiment of the structure of FIG. 2 in its second state; and

FIGS. 5, 6 and 7 are schematic cross-sections of a second embodiment of the invention in three difference states at three difference temperatures.

In the figures, like reference numerals are used to indicate like parts.

The first embodiment illustrated in FIGS. 1 and 2 consists of a structure 10 comprising a stack of layers of materials with particular optical properties. In this context, “optical” refers to any form of electromagnetic radiation, but for the case of temperature regulation, the electromagnetic radiation principally of interest will be in the infrared part of the spectrum.

The terms “front” and “back” used herein are labels to distinguish layers that are on opposite sides of the thermochromic layer, and do not necessarily imply any particular orientation of the structure, nor do they imply that the respective layers are necessarily the outermost layers of the structure.

In this specific embodiment, the front layer 12 is substantially transparent to infrared radiation and has a refractive index whose real part at least partially matches or is comparable with that of the thermochromic layer 14 in particular circumstances as will be described below. In this embodiment the front layer 12 is made of silicon, but other suitable dielectric media, such as germanium could be used. If the silicon, layer 12 is formed by deposition then its thickness can be as low as 100 nm. If the silicon layer 12 is a wafer from a silicon crystal it can be up to 5 mm thick. The device can conveniently be fabricated using a standard 0.5 mm thick silicon wafer as used in the semiconductor electronics industry. The relative thicknesses and aspect ratios of the layers shown in the figures are purely schematic, and not necessarily indicative of the actual relative dimensions.

The layer 14 is made of a thermochromic material, that is a material whose optical properties undergo a change when the material passes through its transition temperature, also known as its critical temperate T_{c}, and which may be known as the temperature at which the material undergoes a semiconductor-to-metal transition, or Mott transition. In this embodiment, the preferred thermochromic material is vanadium dioxide, VO₂, although other suitable materials could be used, for example Fe₃O₄, FeSiO₂, NbO₂, NiS, Ti₂O₃, Ti₄O₇, Ti₅O₉ and V₂O₅.

Vanadium dioxide has a thermochromic transition temperature of approximately 68° C., but the precise temperature can be selected by, for example, the addition of dopants. For example, a particular example of vanadium dioxide with 6% tungsten dopant has a thermochromic transition temperature of 2° C. Doping with intermediate amounts of tungsten between 1% and 5% enables a desired transition temperature in the range of 55° C. to 12.5° C. to be obtained. For applications as a satellite temperature control radiator panel, the transition temperature could, for example, be chosen to be around 20° C. Other suitable dopants include Mo, Li, Re, Nb, Ru, Fe, Co and F for lowering T_{c}, or Ge, Ti for raising T_{c}.

The optical constants n (real part of refractive index) and k (imaginary part of refractive index) for the vanadium dioxide thermochromic layer 14 are as follows for infrared radiation: below the transition temperature (T_{c}) n is approximately equal to 2 and k approaches 0 (i.e. the magnitude of k can be less than 0.5, and may be less than 10⁻³, depending on wavelength and crystallinity); and above the transition temperature, n is approximately 3 or more, and preferably comparable with the refractive index of silicon in the infrared which is approximately 3.5, and k can range from 3 to 6, or even 9, depending on the crystallinity, dopants and stoichiometry of the vanadium dioxide. The thickness of the thermochromic layer 14 is, in one example 70 nm, but could be, for example, in the range of 50 to 250 nm, or even down to 10 nm. In the case of a cermet, comprising a thermochromic material in a dielectric host (described in detail below), the thermochromic material is more diffuse, so the thickness of the layer could be upto approximately 2 μm. The thickness of the thermochromic layer 14 can be selected depending on the value of k of the medium above its critical temperature. The attenuation of electromagnetic radiation on passing through the layer is proportional to e^{-kx} (where x is the optical thickness). Thus, if a medium with a relatively small value of k (in its hot state) were used, the thermochromic layer would need to be thicker in order to achieve the same performance as a thin layer of a material with a higher value of k.

The thermochromic layer 14 can be formed, for example, by reactive sputtering of vanadium in an oxygen atmosphere on to a silicon wafer comprising the front layer 12.

Next there is an optical cavity 16 and a reflective back layer 18. The optical cavity 16 can avoid index matching between the thermochromic layer 14 and the back layer 18, which would otherwise impede the back layer 18 from functioning as a reflector. The optical cavity 16 should have low absorption, such as less than 10% or preferably much lower, so that it is essentially transparent to infrared radiation. The thickness of the optical cavity is ideally in the range of approximately 100 nm to approximately 2 μm. The cavity 16 can simply be a gap containing air or vacuum, for example created by including spacers (not shown) of predetermined thickness between the thermochromic layer 14 and the back layer 18. Suitable spacers would include spheres with diameters of the order of 1 μm. Alternatively, the cavity 16 can be a solid layer of a suitable material, for example a transition metal oxide such as nickel oxide, titanium oxide, molybdenum oxide, tantalum oxide or, for example, titanium hydride, tin oxide or zinc selenide.

The back layer 18 is a highly reflective layer made of, for example, gold platinum, or aluminium. The back layer 18 can be a sheet of polished (clean) metal or a thin film such as 30 run or more in thickness, and can be formed by deposition on any substrate such as electronic components, panels or structural elements. The back layer could have a wavelength-selective reflectivity.

The operation of a device having a structure 10 according to the invention ill now be described, firstly by considering the reflectance of the structure. FIG. 1 shows the device in which the temperature is below the transition temperature of the thermochromic layer 14 (T<T_{c}) such that the thermochromic layer 14 is in its first (cold) state. Considering infrared (IR) radiation incident from the exterior on to the front layer 12 as indicated by the arrow in the upper left part of the figure, a proportion of this radiation will be reflected by the intrinsic reflectivity of the front layer 12, but the majority of the radiation will pass through the front layer 12, the thermochromic layer 14 and the optical cavity 16 because these layers are all essentially IR-transparent. There will, of course, be further small amounts of reflection at each of the interfaces between the layers 12, 14 and 16, but these have been omitted from the figure for clarity. The radiation is then reflected by the back layer 18 and again passes through the IR-transparent layers and exits the device. Thus in this state, the structure is highly reflective. FIG. 3 shows a simulation for a device with a 300 nm thick silicon front layer 12, a 70 nm thick vanadium dioxide thermochromic layer 14 exhibiting idealised optical constant change, and a 1400 nm thick optical cavity 16. The reflectance can be seen to be around 0.96 or higher over a wide range of infrared wavelengths.

FIG. 2 shows the situation with the temperature above the transition temperature of the thermochromic layer 14 (T>T_{c}) such that the thermochromic layer is in its second (hot) state with a significant attenuation coefficient α (proportional to the optical constant k, the imaginary part of the refractive index) so that it is now no longer transparent to infrared radiation. The radiation that reaches the thermochromic layer 14 on the first pass from left to right is attenuated, then reflected off the back layer 18 and is further attenuated on the second pass from right to left. In fact, above the transition temperature, the thermochromic layer 14 is reflective to infrared radiation and so once the radiation has entered the optical cavity 16 it becomes trapped by making multiple reflections between the back layer 18 and the thermochromic layer 14 and is attenuated on each reflection. Consequently, relatively little radiation exits the device so its reflectance is low. FIG. 4 shows the results for the same structure as FIG. 3, and it can be seen that above the transition temperature, the reflectance falls to approximately 0.1 over a wide range of infrared wavelengths. Thus comparing FIGS. 3 and 4, a modulation depth of around 0.85 can be achieved in the reflectance.

Two observations regarding the functioning of the device are noted:

Firstly, the intrinsic reflectance of the silicon front layer 12 is approximately 30%, so in the situation of FIG. 2, it might be expected that the minimum reflectance would be 0.3. However, by choosing the optical thicknesses of the front layer 12 and all other layers to be approximately one quarter of the wavelength of the radiation in that material when in the high temperature state, the structural conditions are selected for destructive interference so that front layer 12 acts as an anti-reflection coating (AR-coating), and so the reflectance can be reduced below 0.3. An alternative embodiment would be to provide an AR-coating made of a different material on to the surface of the front layer 12. This could be used when the front layer 12 is formed from a standard silicon wafer acting as a substrate. Other anti-reflection structures can be employed, such as a broad wavelength anti-reflection coating comprising a multilayer stack of alternating high and low refractive index materials, or surface roughing of the front layer such that there is effectively a mixing of the material with the surrounding air or vacuum over a certain depth in order to give a slower transition between the two media and therefore reduce the reflectance that would otherwise be caused at a sharp interface. An alternative anti-reflection technique is to use a graded index layer, comprising, for example, a cermet, as will be described later.

Secondly, as noted previously, above the transition temperature, the thermochromic layer 14 is quite reflective in the infrared part of the spectrum. Therefore, in the situation of FIG. 2, if the front layer 12 were absent, most of the radiation would simply be reflected by the thermochromic layer 14 and so no modulation of reflectance would be achieved. This structure embodying the invention uses a switching inversion, such that when the thermochromic material is reflective the structure as a whole is absorptive (emissive), and when the thermochromic layer is below the transition temperature and has low reflectance, the device has a whole has high reflectance (low emittance). The problem is to enable the radiation to enter the thermochromic layer 14 so that it can be absorbed. This is solved by the presence of the front layer 12 which acts effectively as an “impedance matching layer”. The reflectance R at an interface between a first medium with optical constants n₁ and k₁, and a second medium with optical constants n₂ and k₂, for radiation incident from the first medium towards the second medium, assuming normal or near normal incidence, is given by the following equation:

$$R = \frac{{( {n}_{2} - {n}_{1} )}^{2} + {( {k}_{2} - {k}_{1} )}^{2}}{{( {n}_{2} + {n}_{1} )}^{2} + {( {k}_{2} + {k}_{1} )}^{2}} \qquad ( 1 )$$

By making the real parts of the refractive indices n₁ and n₂ comparable, the amount of reflection is substantially reduced such that the majority of the radiation can pass from the first medium (ie. the front layer 12) to the second medium (ie. the thermochromic layer 14). Thus in the second, hot, state above the transition temperature, the front layer 12 has a refractive index n comparable with that of the thermochromic layer 14 so that they are at least partially index-matched. This permits radiation to enter the thermochromic layer where it is absorbed because of the attenuation coefficient of the thermochromic layer above its transition temperature. Below the transition temperature, the index matching is not as important because the intention is to have the radiation reflected as much as possible. Any radiation which is not reflected at the interface is reflected off the back layer 18. The optical constants of the layers below the critical temperature are such that they are substantially IR-transparent, ie. there is minimal absorption.

The above description is simply to explain the optical properties of the structure 10. Although it could be used as a device off which radiation was reflected, and for which the reflectance is modulated by a change in temperature through the transition temperature, the preferred use of this embodiment is as an emitter. Therefore it is not necessary for the functioning of the device for radiation to be incident on the front layer 12. The emittance of a device is equal to one minus its reflectance (assuming no transmittance). Therefore, a device which is a good reflector is a poor emitter, and a device which is a poor reflector is a good emitter. Thus the device 10 of FIG. 1 can be thermally bonded to a body, such as a satellite (not shown), with the front layer 12 exposed such that it can emit radiation to the surroundings. When the temperature of the body is below the transition temperature of the thermochromic layer 14, the structure is in a low emittance (high reflectance) state and so retains thermal energy. When the temperature of the body rises above the transition temperature, the device switches to a high emittance (low reflectance) state to provide enhanced loss of thermal energy to cool the body. The device can automatically cycle between the two states switching its emittance in response to the temperature of the body.

All of the embodiments illustrated herein comprise a reflective back layer. However, these are only illustrative examples of embodiments of the invention. The back layer is not essential for the invention. The emittance of the device, which is to be varied or modulated, is proportional to the absorption of the device. All radiation incident on a structure must be either transmitted, reflected, or absorbed (by conservation of energy) and therefore the absorption factor A can be written as follows:

A=1−(T+R)

where T is the transmitance and R is the reflectance. Therefore in a structure without a reflective back layer, below the transition temperature of the thermochromic material the transmitance T is large (approaches 1) therefore the absorption is small and the emitance is small; above the transition temperature, the transmitance is reduced and hence the emitance is increased. Thus, according to the present invention, the structure with variable emittance can be achieved by modulating either or both of the transmittance and reflectance of the structure. Thus a structure embodying the invention can just comprise the front layer and the thermochromic layer provided as a sheet which can, for example, simply be glued to a body which it is intended to thermo-regulate or temperature monitor. However, for efficient operation of any embodiment of the invention, it is preferable that the thermochromic material is in good thermel contact with the relevant body.

As stated previously, one problem addressed by the invention is to enable radiation to enter the thermochromic layer when above its transition temperature, even when the thermochromic material is essentially reflective. This is achieved by minimising difference in real part of refractive index between the front layer and the thermochromic layer. However, for particular thermochromic layers there may not be a single suitable fundamental material having the desired refractive index properties. However, a further embodiment of the invention is to use a composite material in which the refractive index can be tailored to desired values. A specific example of a class of composite material is a cermet, which comprises a dispersion of metal particles in a dielectric (ceramic) host. Cermet materials are mixed metal-ceramic systems in which the optical properties of the whole material are governed by the fraction of each material that is contained within the cermet. Thin films of cermet material can be fabricated using physical deposition sputtering or evaporation. These films can be extremely resillient and visually tuned to any colour. It can be shown that a medium consisting of metal particles much smaller than the wavelength of particular electromagnetic radiation (in this case infrared radiation), and distributed in a host, is equivalent to a homogeneous medium with an effective refractive index n′ and effective dielectric constant ε′. For modelling the medium, the metal particles can be approximated as spheres, and it can be shown that the effective properties depend only upon the relative volume of the metal q (fill factor) and not on the radii of the individual spheres. Maxwell and Garnet derived the following relationship for low fill factors, q<0.3:

$$\frac{{ϵ}^{′} - {ϵ}_{i}}{{ϵ}^{′} + 2 {ϵ}_{i}} = q \frac{ϵ - {ϵ}_{i}}{ϵ + 2 {ϵ}_{i}}$$

where ε′ is the effective dielectric constant of the cermet, εᵢ is the dielectric constant of the host medium into which the metal spheres are imbedded, and ε is the dielectric constant of the metal. This has become known as the Maxwell Garnet equation.

A specific example of a cermet film for use with the present invention is copper in Al₂O₃.

A further embodiment of the present invention is to use a material for the front layer in which the refractive index is stepped or graded. This can be achieved with composite materials by changing their composition. In the case of stepped index changes, there are a number of small discrete changes in composition and hence refractive index from the front to the back of the layer such that the change in refractive index at any step is lessened which results in an overall reduction in intrinsic or interfacial reflection. In the case of a graded index material, the composition and refractive index varies smoothly from the front to the back of the layer such that the front surface of the medium can be more closely indexed-matched to the environment and the back-surface of the front layer can be more closely indexed-matched with the thermochromic layer above its transition temperature. Again this reduces reflection which would otherwise be detrimental to the depth of modulation of the emittance.

A further embodiment of the invention is to modify the properties of the thermochromic layer such that it is more closely indexed-matched to the front layer, and one way of doing this would be to form the thermochromic layer as a cermet composite in which the metal particles are replaced by a dispersion of particles of the thermochromic material (above the transition temperature, thermochromic material exhibits metallic behaviour). The composition of the layer could be varied, as described above to create a stepped or graded index thermochromic layer comprising, for example pure or a high proportion of thermochromic material at the rear surface of the layer and a decreasing proportion of the thermochromic material mixed in a dielectric host towards the front interface with the front layer.

Another embodiment of the invention is to extend this idea and to eliminate a defined interface between the front layer and the thermochromic layer to effectively form a uni-layer structure comprising a cermet film of thermochromic material in a dielectric material. Preferably the composition would be varied from pure thermochromic material at the rear surface for optimal absorption properties to low refractive index at the front surface for matching to the ambient surroundings. Any arbitrary plane through this structure parallel to the front and back faces could constitute a division between the front layer and thermochromic layer, and it would be apparent that at any such interface the difference in refractive index is essentially zero and so there is ideal index-matching, even when the thermochromic material is above the transition temperature. In this example of inhomogeneous layers, the relevant refractive index could be considered to be that immediately on either side of the (arbitrary) interface. Alternatively, the front and back surfaces could be considered as the respective front layer and thermochromic layer (where the composition might be substantially 100% dielectric or thermochromic material) and the graded material in between could be considered to be a thick transitional layer. Another way of depicting a graded material is to consider it to be a stack of many, many layers, each thermochromically switchable, and having a slightly different composition such that the refractive index makes a gradual transition from low to high from the front to back of the structure.

The features of the layers described above, may, of course, be used in place of the front layer and/or thermochromic layer in any of the embodiments of the invention described herein.

When a structure embodying the invention is used as a temperature activated thermal radiator, as explained above, the structure can be provided as one or more discrete patches provided on the body, such as a satellite, or could be integrally formed with the surface coating of the body. Alternatively, a panel could be provided which comprises one or an array of such devices. It is not necessary for the structure to be planar, it can conform to a desired shape. For applications such as on a satellite, it is preferable to avoid the performance being affected by incident solar radiation if for some reason the thermal radiator panel happens to face the sun or faces the earth, which reflects solar radiation. One way to achieve this is to provide a thin multilayer stack on the front of the device which is a broadband reflector in the region of the peak intensity wavelength of solar radiation, but which is transparent to longer wavelength thermal infrared radiation. The peak of solar radiation intensity is in the visible part of the spectrum, so for these purposes it is preferable to reflect radiation with a wavelength in the range of approximately 300 nm to 1.5 or 2 μm. A second way to achieve this is to use layers for the structure which are substantially transparent to peak solar radiation, except for a reflective back layer. In either case the device as a whole is reflective to solar radiation which would otherwise cause unwanted heating, but the operation in the thermal infrared is substantially unchanged.

A further application of the device is in the field of temperature monitoring and/or control. There are circumstances where it is desirable to monitor the temperature of a component to determine whether or not the temperature has exceeded a threshold value. However, it may be impractical or dangerous physically to get close to the component, for example, in a high voltage electricity transmission system, a chemical plant or a nuclear power station, so the sensing must be done remotely. However, it is also not feasible to instal for example electrical thermocouples as temperature sensors. In this case, the structure according to the invention can be used in conjunction with an infrared detector which may optionally be in the form of a thermal-imaging camera. A panel or patch of the layered structure according to the invention is provided in thermal contact with the component or body which is to be monitored. The transition temperature of the thermochromic layer 14 is selected, for example by the choice of the material, the crystallinity, and dopant concentration, such that it corresponds to the threshold temperature which it is desired to monitor. When the component is below the threshold temperature, the structure 10 is highly reflective, but a poor radiator so will only emit a low level of infrared radiation. Above the critical temperature, the structure 10 will switch to a high emittance state and so will emit a significant amount of infrared radiation which can be detected by an appropriate sensor. Thus, whether the structure 10 is emitting or not in the infrared gives a clear indication of whether the component is above or below the threshold temperature, and there is a sharp step change in the emittance of the device which is reversible.

A further embodiment of the invention is illustrated in FIGS. 5, 6 and 7. The structure 20 is identical in all respects to the structure 10 previously described, except that the optical cavity 16 contains a second front layer 22 in contact with a second thermochromic layer 24, and the optical cavity 16 is divided into a front optical cavity 16a and a back optical 16b. The first thermochromic layer 14 has a transition temperature T₁ and the second thermochromic layer 24 has a transition temperature T₂. In this example the two transition temperatures are different from each other and T₂ is greater than T₁.

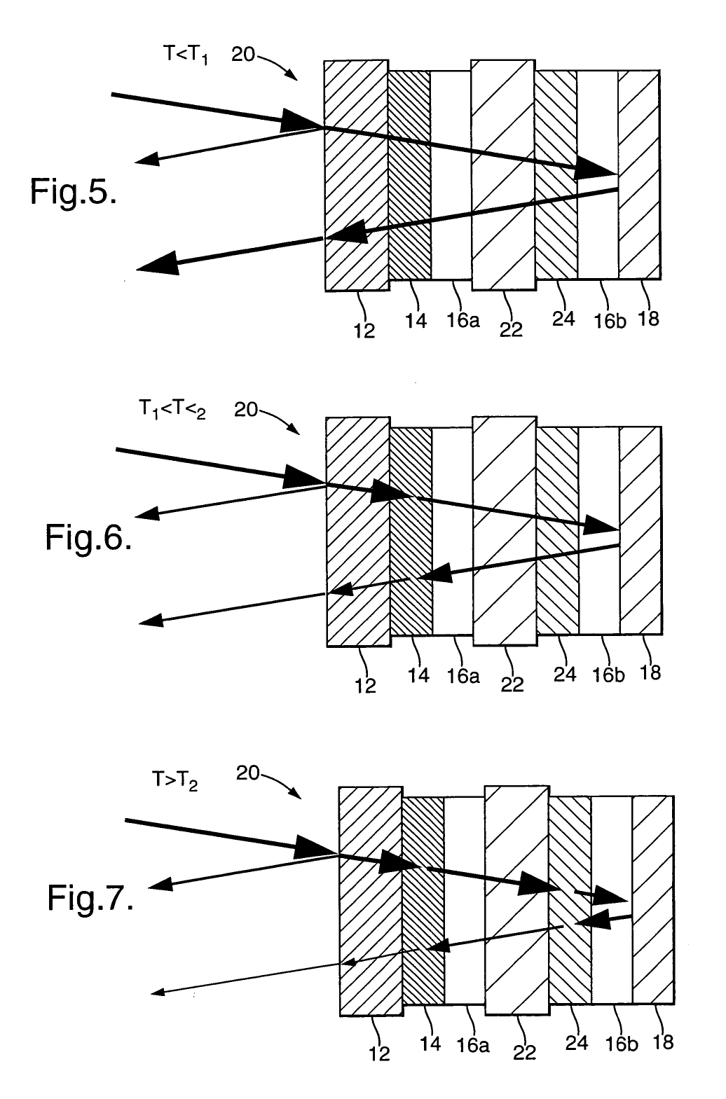

As shown in FIG. 5, when the temperature is below the transition temperature of both thermochromic layers, all the layers except the back layer 18 are essentially IR-transparent, and so the structure 20 has a very high reflectance, governed principally by the reflective back layer 18. When the temperature of the structure 20 is above the transition temperature T₁ of the first thermochromic layer 14, but below the transition temperature T₂ of the second thermochromic layer 24, the situation depicted schematically in FIG. 6 arises. The first thermochromic layer 14 is now in its second (hot) state and so acts as an absorber with the results that the reflectance of the structure 20 is reduced by a certain amount. FIG. 7 shows the situation in which the temperature is above the transition temperatures of both thermochromic layers 14 and 24, so that they are both in their second (hot) states and both act as absorbers, so that the overall reflectance of the structure 20 is further reduced.

As an illustrative calculation, assuming that the attenuation coefficients and thicknesses of the thermochromic layers 14 and 24 are such that when in their second (hot) state, 10% of the radiation is absorbed on each passage through each thermochromic layer. In the low temperature state shown in FIG. 5, the reflectance is close to 100%. In the intermediate temperature state shown in FIG. 6, the radiation makes two passes through the absorbing thermochromic layer 14 (ignoring multiple reflections), so the reflectance is approximately 81% [ie. (1−0.1)²]. In the high temperature state shown in FIG. 7, the radiation makes four passes through absorbing layers, and so the reflectance is approximately 65% [ie. (1−0.1)⁴].

These changes in reflectance, and hence consequent changes in emittance can readily be detected by an infrared sensor, which can typically sense emission changes of less than 1%.

The structure 20 of this embodiment could be applied to temperature sensing, as described above, but where it is desired to determine whether a component is within a particular band of temperatures. The upper and lower threshold temperatures of the band are set by the transition temperature T₂ of the second thermochromic layer and the transition temperature T₁ of the first thermochromic layer 14. A step change of several percent in the emittance above and below the desired temperature band enables the three states of FIGS. 5, 6 and 7 to be readily distinguished by an infrared sensor. This could be used to give an indication of a fault condition, or with appropriate feedback and control circuitry could be used to take necessary action to return the component to the optimal operating temperature band.

The order of the first and second thermochromic layers could of course be reversed, and further pairs of front layers and thermochromic layers could be included in the optical cavity or cavities to provide a structure capable of indicating many different temperature bands or threshold temperatures.

It is again emphasised that in this mode of operation of the device, as in the preceding modes, it is not necessary for radiation to be incident on the structure, nor for it to act as a reflector, although this would be one option. Instead, it is envisaged that the structure would be used as an emitter (i.e. radiator) which emits thermal radiation. The variation of emittance, as a function of temperature, is a corollary of the variation in reflectance.

1. A structure, having variable emittance, comprising:
a front layer comprising a dielectric material; and
a thermochromic layer comprising a thermochromic material,
wherein the thermochromic material has a first state, below a transition temperature, in which the imaginary part of the refractive index of the thermochromic material has a first value, and a second state, above the transition temperature, in which the imaginary part of the refractive index of the thermochromic layer has a second value, greater than said first value, and
wherein the magnitude of the difference between the real part of the refractive index of the thermochromic layer and the real part of the refractive index of the front layer when the thermochromic material is in the second state is smaller than or the same as when the thermochromic material is in said first state, such that the emittance of the structure when the thermochromic material is in the second state is greater than the emittance when the thermochromic material is in said first state.

2. A structure according to claim 1, wherein the first value of the imaginary part of the refractive index of the thermochromic material is smaller in magnitude than 0.5, and preferably smaller than 0.001.

3. A structure according to claim 1 or 2, wherein, when the thermochromic material is in said second state, the real part of the refractive index of the thermochromic layer is comparable to the real part of the refractive index of the front layer.

4. A structure according to any one of the preceding claims, wherein the thermochromic material comprises vanadium dioxide.

5. A structure according to claim 4, wherein the vanadium dioxide is doped with tungsten.

6. A structure according to any one of the preceding claims, wherein the thickness of the thermochromic layer is in the range of from 10 nm to 2 μm.

7. A structure according to any one of the preceding claims, wherein the thermochromic material has a transition temperature in the range of from −25° C. to 100° C., more preferably in the range of from −5° C. to 65° C., and more preferably in the range of from 10° C. to 30° C.

8. A structure according to any one of the preceding claims, wherein the dielectric material of the front layer comprises silicon or germanium.

9. A structure according to any one of the preceding claims, wherein the front layer comprises a cermet material.

10. A structure according to any one of the preceding claims, wherein the refractive index of the front layer is graded from front to back, such that at the interface between the front layer and the thermochromic layer, the real parts of their refractive indexes substantially match.

11. A structure according to any one of the preceding claims, wherein the thickness of the front layer is in the range of from 100 nm to 5 mm.

12. A structure according to any one of the preceding claims, further comprising a back layer, on the opposite side of the thermochromic layer to the front layer, said back layer being reflective to electromagnetic radiation.

13. A structure according to 12, wherein said back layer comprises a metallic material.

14. A structure according to claim 13, wherein the back layer comprises at least one of gold, platinum and aluminium.

15. A structure according to any one of claims 12 to 14, further comprising an optical cavity between the thermochromic layer and the back layer.

16. A structure according to claim 15, wherein the real part of the refractive index of the optical cavity is dissimilar to the real part of the refractive index of the thermochromic layer.

17. A structure according to claim 15 or 16, wherein the optical cavity comprises vacuum or a medium that is substantially transparent to electromagnetic radiation.

18. A structure according to claim 15, 16 or 17, wherein the thickness of the optical cavity is in the range of from 100 nm to 2 μm.

19. A structure according to any one of the preceding claims, comprising an anti-reflection coating in front of the thermochromic layer.

20. A structure according to claim 19, wherein the anti-reflection coating comprises the front layer.

21. A structure according to any one of the preceding claims, wherein the thermochromic layer comprises a dispersion of thermochromic material in a dielectric material host.

22. A structure according to any one of the preceding claims, wherein the front layer comprises a dispersion of thermochromic material in a dielectric material host.

23. A structure according to claim 21 or 22, wherein the proportion of thermochromic material in said dispersion increases away from the front surface of the front layer.

24. A structure according to any one of the preceding claims, wherein there is no defined interface between the front layer and the thermochromic layer.

25. A structure according to any one of the preceding claims, comprising at least one further thermochromic layer, and wherein each thermochromic layer has a different thermochromic transition temperature.

26. A structure according to any one of the preceding claims, wherein the refractive index properties are defined for thermal infrared electromagnetic radiation.

27. A thermal radiator comprising a structure according to any one of the preceding claims.

28. A satellite comprising a structure according to any one of claims 1 to 26 or comprising a thermal radiator according to claim 27.

29. A temperature monitor comprising a structure according to any one of claims 1 to 26.

30. A method of thermal regulation of a body, comprising providing the body with at least one structure according to any one of claims 1 to 26.

31. A method of temperature monitoring, comprising monitoring radiation from a structure according to any one of claims 1 to 26, and determining whether the radiation emission is above or below at least one threshold value.
